(19) United States
(12) Patent Application Publication
(10) Pub. No.: US 2025/0250364 A1
(43) Pub. Date: Aug. 7, 2025

(54) PARAMYLON-BASED RESIN AND PRODUCING METHOD THEREOF, MOLDING RESIN COMPOSITION, AND MOLDED BODY

(71) Applicant: NEC Corporation, Minato-ku, Tokyo (JP)

(72) Inventors: Midori SHIMURA, Tokyo (JP); Shukichi TANAKA, Tokyo (JP)

(73) Assignee: NEC Corporation, Minato-ku, Tokyo (JP)

(21) Appl. No.: 18/856,103

(22) PCT Filed: Apr. 26, 2022
(86) PCT No.: PCT/JP2022/018816

§ 371 Date: Oct. 11, 2024

(51) Int. Cl. C08B 37/00; C08L 5/00

(52) U.S. Cl. CPC C08B 37/0024; C08L 5/00

(57) ABSTRACT

[Problem to be Solved]

An object of the present invention is to provide a method for easily producing a paramylon-based resin having improved mechanical properties at low cost.

[Solution]

A method for producing a paramylon-based resin, comprising:
dispersing paramylon having a weight-average molecular weight of 220,000 to 500,000 in a solvent comprising N-methylpyrrolidone and/or pyridine;
acylating hydroxyl groups of the paramylon by adding a short-chain acylating agent, which is acetyl chloride and/or propionyl chloride, and a long-chain acylating agent, which is an acid chloride of a saturated fatty acid having 12 or more carbon atoms, to the paramylon dispersion liquid; and
recovering the paramylon-based resin obtained by the acylation;
wherein in the acylation, the weight ratio (B+C)/A is 17.5 to 60.0, wherein A is the dry weight of paramylon, B is the total weight of the solvent, and C is the total weight of the short-chain acylating agent and the long-chain acylating agent.

### TECHNICAL FIELD

The present invention relates to a paramylon-based resin made from paramylon and a producing method thereof, a molding resin composition, and a molded body.

### BACKGROUND ART

In recent years, the development of bioplastics made from plant materials has been promoted from the viewpoint of reducing the environmental impact. Conventional bioplastics, such as polylactic acid, polyhydroxyalkanoate and starch modification, are all made from starch-based materials, i.e., edible parts of plants. Due to concerns about future food shortages, there is a demand for the development of bioplastics made from inedible parts of plants.

As inedible parts of plants, attention is focused on woody biomass such as wood and vegetation, and algal biomass. In particular, algae can be cultivated even on land unsuitable for farming, so they do not compete with food production. In addition, algae can be cultivated repeatedly in a cyclical manner using CO₂, nutrients and sunlight, making it possible to use them sustainably as an alternative to fossil resource. Further, algae can produce useful organic components, in particular, long-chain fatty acids and polysaccharides, which are effective as major components of bioplastics, with high efficiency.

β-1,3 glucan (paramylon) is known as an algae-derived polysaccharide. Paramylon is a polysaccharide in which glucose units are linked in a linear chain only by β-1,3 bonds, and has no thermoplasticity due to the strong intermolecular forces caused by hydrogen bonds derived from hydroxyl groups. For this reason, bioplastics that use paramylon are endowed with thermoplasticity by adding various substituents to the paramylon.

For example, Patent Document 1 describes a paramylon derivative in which paramylon is acylated using an acylating agent that is a reaction product of a short-chain carboxylic acid and a short-chain carboxylic anhydride, and Patent Document 2 describes a paramylon derivative in which hydroxyl groups of paramylons are substituted with long-chain acyl groups. However, these paramylon derivatives are substituted only with either short-chain acyl groups or long-chain acyl groups, and have insufficient thermoplasticity and mechanical properties.

Patent Document 3 describes a method for producing paramylon derivatives substituted with long-chain acyl groups and short-chain acyl groups, in which a chloride of a long-chain aliphatic carboxylic acid having 13 or more carbon atoms is added to paramylon dissolved in a solvent to acylate some of hydroxyl groups of the paramylon, and then acetic anhydride or propionic anhydride is added to acylate the remaining hydroxyl groups.

However, the above-mentioned method requires complicated procedures, and a large amount of solvent to dissolve the paramylon. Therefore, an improved production method is required from the standpoint of cost and resource circulation.

### CITATION LIST

### Patent Document

Patent Document 1: JP2017-193667A
Patent Document 2: JP2018-154723A
Patent Document 3: JP6029155B

### SUMMARY OF INVENTION

### Technical Problem

An object of the present invention is to provide a method for easily producing a paramylon-based resin having improved mechanical properties at low cost.

### Solution to Problem

In one aspect of the present invention,
a method for producing a paramylon-based resin, comprising:
dispersing paramylon having a weight-average molecular weight of 220,000 to 500,000 in a solvent comprising N-methylpyrrolidone and/or pyridine;
acylating hydroxyl groups of the paramylon by adding a short-chain acylating agent, which is acetyl chloride and/or propionyl chloride, and a long-chain acylating agent, which is an acid chloride of a saturated fatty acid having 12 or more carbon atoms, to the paramylon dispersion liquid; and
recovering the paramylon-based resin obtained by the acylation;
wherein in the acylation, the weight ratio (B+C)/A is 17.5 to 60.0, wherein A is the dry weight of paramylon, B is the total weight of the solvent, and C is the total weight of the short-chain acylating agent and the long-chain acylating agent,
   is provided.

### Advantageous Effect of Invention

According to the present invention, a method for easily producing paramylon-based resin having improved mechanical properties at low cost can be provided.

### DESCRIPTION OF EMBODIMENTS

### [1] Method for Producing Paramylon-Based Resin

The method for producing a paramylon-based resin of the present invention comprises:
dispersing paramylon having a weight-average molecular weight of 220,000 to 500,000 in a solvent comprising N-methylpyrrolidone and/or pyridine;
acylating hydroxyl groups of the paramylon by adding a short-chain acylating agent, which is acetyl chloride and/or propionyl chloride, and a long-chain acylating agent, which is an acid chloride of a saturated fatty acid having 12 or more carbon atoms, to the paramylon dispersion liquid; and
recovering the paramylon-based resin obtained by the acylation;
wherein in the acylation, the weight ratio (B+C)/A is 17.5 to 60.0, wherein A is the dry weight of paramylon, B is the total weight of the solvent, and C is the total weight of the short-chain acylating agent and the long-chain acylating agent,

### [Dispersion Step]

### (Paramylon)

Paramylon is a linear polymer formed by polymerization of β-D-glucose molecules (6-D-glucopyranose) via B (1-+3) glycosidic bonds, as shown in the following formula (1) (wherein n is a natural number). Each glucose unit that constitutes paramylon has three hydroxyl groups.

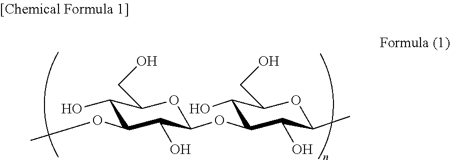

The weight-average molecular weight of the paramylon used in the method for producing the paramylon-based resin of the present invention, as measured by gel permeation chromatography (GPC), is 220,000 to 500,000, preferably 225,000 to 470,000, and more preferably 230,000 to 440,000.

### (GPC Measurement Conditions for Paramylon)

Column: PLgel 20 μm MIXED-A (product name, manufactured by Agilent Technologies, Inc.)
Eluent: Dimethylacetamide (DMAc) solution (0.1M LiCl)
Flow rate: 0.5 mL/min
Detector: RI (differential refractive index) (manufactured by Tosoh Corporation, RI-71 type 201 (16×))
Temperature: 23.0° C.
Standard sample: Pullulan standard

The dispersion step of the present invention is a step in which paramylon is dispersed in a solvent. In this step, an activation treatment is performed to increase the reactivity of paramylon. The activation treatment is a treatment of contacting paramylon with a solvent to swell the paramylon. This treatment makes it easier for reactants and catalysts to penetrate between the paramylon molecular chains, thereby increasing the reactivity of paramylon. The temperature of the dispersion step can be appropriately set in the range of, for example, 0 to 100° C. From the viewpoint of activation efficiency and energy cost reduction, the temperature of the dispersion step is preferably 10 to 40° C., and more preferably 15 to 35° C. The time of the dispersion step can be appropriately set in the range of, for example, 3 to 72 hours. From the viewpoint of sufficient activation and reducing the processing time, the time of the dispersion step is preferably 5 to 48 hours, and more preferably 7 to 24 hours. In the method of the present invention, paramylon is not necessary to be completely dissolved in the solvent, and it is sufficient to be dispersed in the solvent, so the amount of solvent used can be reduced. In general, when using paramylon with a large molecular weight, if the amount of solvent is small, the reaction solution becomes highly viscous, the reaction becomes heterogeneous, and the physical properties of the product may be reduced. It is also conceivable that paramylon may be hydrolyzed with an acid or base as a pretreatment to adjust the molecular weight of paramylon. However, in the method of the present invention, such hydrolysis of paramylon with an acid or base is not required.

Paramylon may be mixed with substances having similar structures, such as cellulose, chitin, chitosan, hemicellulose, xylan, glucomannan and curdlan. When such substances are mixed, the content of them is preferably 30% by mass or less, more preferably 20% by mass or less, and even more preferably 10% by mass or less, based on the total mixture.

### (Solvent)

The solvent used in the acylation step of the present invention comprises N-methylpyrrolidone and/or pyridine. The solvent preferably comprises 90% by weight or more of N-methylpyrrolidone and/or pyridine in total, and more preferably consists of N-methylpyrrolidone and pyridine. It is preferable that the solvent comprises pyridine because pyridine has the effect of promoting the esterification reaction as an acid scavenger. The amount of pyridine is preferably 0.1 mol or more, more preferably 0.3 mol or more, and particularly preferably 0.5 mol or more, of the total weight of the short-chain acylating agent and the long-chain acylating agent.

### [Acylation Step]

The acylation step of the present invention is a step in which short-chain acyl groups (acetyl groups and/or propionyl groups) and long-chain acyl groups (saturated aliphatic acyl groups having 12 or more carbon atoms) are simultaneously introduced into hydroxy groups of paramylons.

### (Short-Chain Acylating Agent)

The short-chain acylating agent is acetyl chloride and/or propionyl chloride, and has at least one functional group capable of reacting with a hydroxy group in paramylon. It is more preferable that the short-chain acylating agent is propionyl chloride alone.

### (Long-Chain Acylating Agent)

The long-chain acylating agent is an acid halide of a saturated fatty acid having 12 or more carbon atoms, and has at least one functional group capable of reacting with a hydroxyl group in paramylon. Specific examples of saturated fatty acids having 12 or more carbon atoms include lauric acid, myristic acid, pentadecylic acid, palmitic acid, margaric acid, stearic acid, arachidic acid, behenic acid, lignoceric acid, cerotic acid, montanic acid, and melissic acid, among which myristic acid, palmitic acid, stearic acid, arachidic acid and behenic acid are preferred, and stearic acid is particularly preferred. Furthermore, from the viewpoint of environmental friendliness, it is preferred that the saturated fatty acid is obtained from a natural product. The long-chain acylating agent may be used alone or in combination of two or more types.

The short-chain acyl group and the long-chain acyl group can be introduced into paramylon by reacting a hydroxyl group in paramylon with a short-chain acylating agent and a long-chain acylating agent. The short-chain organic group of the short chain acyl group and the long-chain organic group of the long chain acyl group can be bonded to the pyranose ring of paramylon via an ester bond.

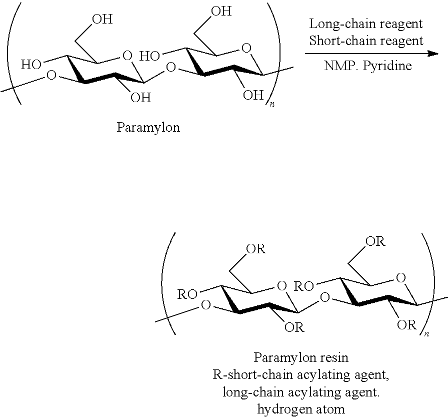

In the acylation step of the present invention, the weight ratio (B+C)/A is 17.5 to 60.0, preferably 18.0 to 50.0, and particularly preferably 18.0 to 40.0, wherein A is the dry weight of paramylon, B is the total weight of the solvent, and C is the total weight of the short-chain acylating agent and the long-chain acylating agent. If the weight ratio (B+C)/A is less than 17.5, the reaction becomes heterogeneous, and if it exceeds 60.0, it is undesirable from the viewpoints of cost and resource circulation.

In the acylation step of the present invention, the weight ratio B/C is preferably 1.0 to 25.0, more preferably 2.0 to 15.0, and particularly preferably 3.0 to 12.0, wherein C is the total weight of the short-chain acylating agent and the long-chain acylating agent and B is the total weight of the solvent. If the weight ratio B/C is less than 1.0 or exceeds 25.0, the reaction may be heterogeneous, which is undesirable from the viewpoints of cost and resource circulation.

In the acylation step, the solvent temperature when the acylating agent (short-chain acylating agent and long-chain acylating agent) is added to the solvent in which paramylon is dispersed is preferably kept between-30° C. and 30° C., and more preferably between −10° C. and 20° C. If the temperature is higher than 30° C., the highly reactive short-chain acylating agent reacts with paramylon preferentially over the long-chain acylating agent, causing the reaction to be heterogeneous and reducing the physical properties of the paramylon ester. After the acylating agent is added, the reaction temperature between the acylating agent and paramylon is preferably 50 to 100° C., more preferably 75 to 95° C. The reaction time can be set appropriately according to the desired degree of substitution. The reaction time can be set from 2 to 10 hours, and preferably from 3 to 6 hours. If the reaction temperature is sufficiently high, the reaction rate can be increased, so that the acylation reaction can be completed in a relatively short time, and the reaction efficiency can be increased. Furthermore, if the reaction temperature is within the above range, the decrease in the molecular weight of paramylon due to heating can be suppressed.

### [Recovery Step]

The paramylon-based resin into which short-chain acyl groups and long-chain acyl groups have been introduced in the acylation step (product) can be recovered from the reaction solution by a conventional method, and the method is not limited thereto. If the product is not dissolved in the reaction solution, a recovery method for solid-liquid separation of reaction solution and product is preferred from the viewpoint of production energy. If the product dissolves in the reaction solution or has an affinity with the reaction solution, making solid-liquid separation difficult, the reaction solution can be distilled off and the product recovered as a residue. Alternatively, a poor solvent for the product may be added to the reaction solution, and the precipitated product may be recovered by solid-liquid separation.

When components other than the product, such as solvent, are distilled off from the reaction solution, the distillation can be stopped at the point when the product precipitates, and then the remaining reaction solution and the precipitated product can be subjected to solid-liquid separation to recover the product.

Examples of solid-liquid separation methods include filtration (natural filtration, reduced pressure filtration, pressure filtration, centrifugal filtration, and hot filtrations of them), natural sedimentation/floating, liquid separation, centrifugation and squeezing, and these may be used in appropriate combination.

The product (paramylon-based resin) dissolved in the filtrate after solid-liquid separation can be precipitated by adding a poor solvent for the product, and can be recovered by further solid-liquid separation. The solid content (paramylon-based resin) recovered from the reaction solution can be washed as necessary and dried by a conventional method.

### [2] Paramylon-Based Resin

The paramylon-based resin of the present invention is a paramylon-based resin in which at least a portion of hydrogen atoms of hydroxyl groups of paramylons having a weight-average molecular weight of 220,000 to 500,000 are substituted with saturated aliphatic acyl groups having 12 or more carbon atoms and acetyl groups and/or propionyl groups, and in which short-chain acyl groups and long-chain acyl groups are introduced into paramylon by utilizing the hydroxyl groups of paramylons.

The short-chain acyl group is an acyl group derived from a short-chain acylating agent introduced in place of a hydrogen atom of a hydroxyl group of paramylons. By introducing a short chain acyl group into paramylon, the intermolecular force (intermolecular bond) of paramylon can be reduced, and mechanical properties such as elastic modulus, chemical resistance and surface hardness can be improved. The short-chain acyl group is an acetyl group or/and a propionyl group, and it is particularly preferable that the short-chain acyl group is only a propionyl group.

The degree of substitution with short-chain acyl groups (DS_{Sh}), i.e., the average number of hydroxyl groups substituted with short-chain acyl groups (acetyl groups and/or propionyl groups) per glucose unit of paramylon (i.e., the degree of hydroxyl group substitution), is not particularly limited, but is preferably in the range of 1.5 to 2.5. In order to fully obtain the effect of introducing short-chain components, DS_{Sh} is more preferably 1.8 or more, and particularly preferably 1.9 or more. In order to fully obtain the effect of introducing short-chain components while fully obtaining the effect of long-chain components, DS_{Sh} is more preferably 2.4 or less, and particularly preferably 2.3 or less.

The long-chain acyl group is an acyl group derived from a long-chain acylating agent introduced in place of the hydrogen atom of the hydroxyl group of paramylons. By introducing a long-chain acyl group into paramylon, its properties can be modified, for example, water resistance, thermoplasticity and mechanical properties can be improved. The long-chain acyl group is a saturated aliphatic acyl group having 12 or more carbon atoms, preferably a saturated aliphatic acyl group having 12 to 22 carbon atoms, more preferably a dodecanoyl group (C12), a tetradecanoyl group (C14), a hexadecanoyl group (C16), an octadecanoyl group (C18), an icosanoyl group (C20), or a docosanoyl group (C22), and particularly preferably an octadecanoyl group (C18). The long-chain acyl group may be of one type alone or of two or more types.

The degree of substitution with long-chain acyl groups (DS_{Lo}), i.e., the average number of hydroxyl groups substituted with long-chain acyl groups (saturated aliphatic acyl groups having 12 or more carbon atoms) per glucose unit of paramylon (i.e., the degree of hydroxyl group substitution), is not particularly limited, but is preferably in the range of 0.1 to 0.8, more preferably in the range of 0.2 to 0.7, and particularly preferably in the range of 0.3 to 0.6. The introduction of long-chain acyl groups can improve thermoplasticity and water resistance. In addition, the presence of an appropriate ratio of long-chain acyl groups and short-chain acyl groups can improve mechanical properties such as tensile strength and elastic modulus.

### [3] Molding Resin Composition

The paramylon-based resin of the present invention can be used as a base resin for a molding resin composition by adding additives depending on the desired properties. Here, the base resin means a main component of the molding resin composition, and means that other components are allowed to be contained within a range that does not impair the function of the main component. The content of the main component is not particularly specified, but includes that the main component accounts for 50% by mass or more, preferably 70% by mass or more, more preferably 80% by mass or more, and particularly preferably 90% by mass or more of the composition.

Various additives used in ordinary thermoplastic resins can be used in the molding resin composition of the present invention. For example, the addition of a plasticizer can further improve the thermoplasticity and elongation at break. Examples of such plasticizers include phthalate esters such as dibutyl phthalate, diaryl phthalate, diethyl phthalate, dimethyl phthalate, di-2-methoxyethyl phthalate, ethyl phthalyl ethyl glycolate, and methyl phthalyl ethyl glycolate; tartrate esters such as dibutyl tartrate; adipic acid esters such as dioctyl adipate and diisononyl adipate; polyhydric alcohol esters such as triacetin, diacetyl glycerin, tripropionitrile glycerin, and glycerin monostearate; phosphate esters such as triethyl phosphate, triphenyl phosphate, and tricresyl phosphate; dibasic fatty acid esters such as dibutyl adipate, dioctyl adipate, dibutyl azelate, dioctyl azelate, and dioctyl sebacate; citric acid esters such as triethyl citrate, acetyl triethyl citrate, and acetyl tributyl citrate; epoxidized vegetable oils such as epoxidized soybean oil and epoxidized linseed oil: castor oil and its derivatives; benzoic acid esters such as ethyl O-benzoylbenzoate; aliphatic dicarboxylic acid esters such as sebacic acid esters and azelaic acid esters; unsaturated dicarboxylic acid esters such as maleic acid esters; others such as N-ethyltoluenesulfonamide, triacetin, O-cresyl p-toluenesulfonate, and tripropionin. In particular, the addition of plasticizers such as dioctyl adipate, benzyl 2-butoxyethoxyethyl adipate, tricresyl phosphate, diphenylcresyl phosphate and diphenyloctyl phosphate can effectively improve not only thermoplasticity and elongation at break but also impact resistance.

Other plasticizers include cyclohexanedicarboxylate esters such as dihexyl cyclohexanedicarboxylate, dioctyl cyclohexanedicarboxylate and di-2-methyloctyl cyclohexanedicarboxylate; trimellitic acid esters such as dihexyl trimellitate, diethylhexyl trimellitate and dioctyl trimellitate; and pyromellitic acid esters such as dihexyl pyromellitate, diethylhexyl pyromellitate and dioctyl pyromellitate.

An inorganic or organic granular or fibrous filler can be added to the molding resin composition of the present invention, as necessary. The strength and the rigidity can be further improved by adding a filler. Examples of fillers include mineral particles (talc, mica, calcined silica earth, kaolin, sericite, bentonite, smectite, clay, silica, quartz powder, glass beads, glass powder, glass flakes, milled fiber and wollastonite (or wollastonite)); boron-containing compounds (boron nitride, boron carbide, and titanium boride); metal carbonates (magnesium carbonate, heavy calcium carbonate, and light calcium carbonate); metal silicates (calcium silicate, aluminum silicate, magnesium silicate, and magnesium aluminosilicate); metal oxides (magnesium oxide); metal hydroxides (aluminum hydroxide, calcium hydroxide, and magnesium hydroxide); metal sulfates (calcium sulfate and barium sulfate); metal carbides (silicon carbide, aluminum carbide, and titanium carbide); metal nitrides (aluminum nitride, silicon nitride, and titanium nitride); white carbon; and various metal foils. Examples of fibrous fillers include organic fibers (natural fibers and paper), inorganic fibers (glass fibers, asbestos fibers, carbon fibers, silica fibers, silica-alumina fibers, wollastonite, zirconia fibers, and potassium titanate fibers) and metal fibers. The fillers can be used alone or in combination.

A flame retardant can be added to the molding resin composition of the present invention, as necessary. Flame retardancy can be imparted by adding a flame retardant. Examples of flame retardants include metal hydrates such as magnesium hydroxide, aluminum hydroxide, and hydrotalcite, basic magnesium carbonate, calcium carbonate, silica, alumina, talc, clay, zeolite, bromine-based flame retardants, antimony trioxide, phosphoric acid-based flame retardants (aromatic phosphoric acid esters and aromatic condensed phosphoric acid esters), and compounds containing phosphorus and nitrogen (phosphazene compounds). The flame retardants can be used alone or in combination of two or more types.

There are no particular limitations on the method for producing the molding resin composition in which various additives are added to the paramylon-based resin of the present invention. For example, the molding resin composition can be produced by melt-mixing the various additives with the paramylon-based resin by hand mixing, and other compounding devices such as known mixers such as tumbler mixers, ribbon blenders, single-screw or multi-screw mixer extruders, kneading kneaders and kneading rolls, and granulating the mixture into an appropriate shape as necessary. Another suitable manufacturing method involves mixing various additives dispersed in a solvent such as an organic solvent with paramylon-based resin, adding a solidification solvent as necessary to obtain a mixed composition of the various additives and paramylon-based resin, and then evaporating the solvent.

### [4] Molded Body

The molded body of the present invention is produced by molding a molding resin composition using a paramylon-based resin as a base resin. The molding method includes, for example, extrusion molding, injection molding and blow molding.

The molded body of the present invention has an IZOD impact strength of 5.0 KJ/m² or more, preferably 7.0 KJ/m² or more, and particularly preferably 8.0 KJ/m² or more. The molded body of the present invention has an MFR (melt flow rate at 210° C. and a load of 5 kg) of 5.0 g/10 min or more, preferably 7.0 g/10 min or more, and particularly preferably 8.0 g/10 min or more.

The applications of the molded body of the present invention are not particularly limited, but it is suitable for molded body such as housings for exterior parts of electronic devices, for example.

### EXAMPLES

The present invention will be described in detail below with reference to Examples, but the present invention is not limited to Examples.

### Synthesis of Paramylon-Based Resin (Paramylon Propionate Stearate)

### Synthesis Example 1

(1) Paramylon (manufactured by Wako Pure Chemical Industries, the weight average molecular weight: 239,000) was placed in a sample bottle and dried for 5 hours in a vacuum dryer set at 105° C. 9.1 g of the dried paramylon was added to a mixed solvent of 122.8 g (119.6 mL) of N-methylpyrrolidone and 16.3 g (16.6 mL) of pyridine, and the mixture was stirred overnight at room temperature under a nitrogen atmosphere.
(2) After cooling the paramylon dispersion liquid of (1) to −4° C., 8.5 g (28.0 mmol) of stearoyl chloride and 15.5 g (168 mmol) of propionyl chloride that had been mixed in advance were added to the paramylon dispersion liquid of (1) while keeping the temperature below 10° C., and the mixture was heated to 90° C. and stirred for 4 hours while heating.
(3) The reaction solution was then cooled to 65° C., 58 mL of methanol was added dropwise, and the mixture was stirred for about 30 minutes. Further, 13 mL of water was added to precipitate the product. The product was collected by suction filtration, washed five times with 54 mL of a methanol/water mixture (9/1 v/v), and vacuum dried at 105° C. for five hours to obtain a paramylon-based resin (yield: 19.2 g (90%)).

### Synthesis Example 2

A paramylon-based resin was obtained in the same manner as in Synthesis Example 1, using 4.2 g of the dried paramylon, 54.1 g (52.7 mL) of N-methylpyrrolidone, 7.2 g (7.3 mL) of pyridine, 10.3 g (34.0 mmol) of stearoyl chloride and 5.6 g (60.5 mmol) of propionyl chloride (yield: 7.1 g (79%)).

### Synthesis Example 3

A paramylon-based resin was obtained in the same manner as in Synthesis Example 1, using 5.0 g of the dried paramylon, 128.6 g (125.2 mL) of N-methylpyrrolidone, 17.0 g (17.3 mL) of pyridine, 5.3 g (17.6 mmol) of stearoyl chloride and 8.1 g (87.9 mmol) of propionyl chloride (yield: 9.2 g (79%)).

### Synthesis Example 4

A paramylon-based resin was obtained in the same manner as in Synthesis Example 1, using 4.2 g of the dried paramylon, 54.1 g (52.7 mL) of N-methylpyrrolidone, 7.2 g (7.3 mL) of pyridine, 3.7 g (12.3 mmol) of stearoyl chloride, and 6.8 g (73.9 mmol) of propionyl chloride (yield: 7.5 g (86%)).

The paramylon-based resins obtained in Synthesis Examples 1 to 4 were measured and evaluated as follows. The results are shown in Table 1.

### [Measurement of Glass-Transition Temperature (Tg)]

The glass transition temperature was determined by differential scanning calorimetry (DSC) under the following conditions. EXSTAR2000 and DSC6200 from Seiko Instruments Inc. were used as measuring instruments. The paramylon-based resin was heated from 20° C. to 200° C. at 10° C./min, and then rapidly cooled from 200° C. to −30° C. at 50° C./min. The glass-transition temperature (Tg) of the paramylon-based resin was then measured when the temperature was raised from −30° C. to 200° C. at 20° C./min.

### [Formation of Molded Body]

A molded body having a thickness of 2.4 mm, a width of 12.4 mm, and a length of 80 mm was produced from the paramylon-based resins obtained above, using injection molding (HAAKE MiniJet II, manufactured by Thermo Electron Corporation). At that time, the molding conditions were set as follows: cylinder temperature of the molding machine was 200° C. (Synthesis Examples 1 and 3) or 210° C. (Synthesis Examples 2 and 4), the mold temperature was 65° C., the injection pressure was 1200 bar (120 MPa) for 5 seconds, and the holding pressure was 600 bar (60 MPa) for 20 seconds.

### [Measurement of Bending Strength, Bending Modulus and Bending Breaking Strain]

The molded body obtained was subjected to a bending test in accordance with JIS K7171 to measure the bending strength, bending modulus and breaking strain.

### [Measurement of IZOD Impact Strength]

The notched IZOD impact strength of the molded body obtained was measured under the conditions specified in JIS K7110. The obtained data was evaluated according to the following criteria.

### (Evaluation Criterion of IZOD Impact Strength)

∘: 5.0 KJ/m² or more
x: less than 5.0 KJ/m²

### [Measurement of Flowability (Melt Flow Rate (MFR))]

The MFR of the molded body obtained was measured using Koka flow tester (manufactured by Shimadzu Corporation, product name: CFT-500D) under the conditions of temperature 210° C., load 5 kg, die 2 mmφ×10 mm (hole diameter 2 mm, hole length 10 mm), and residual heat 2 minutes (the time from when the sample is filled into the cylinder and the piston was inserted to when the load is applied) based on JIS 7210:1990. The obtained data was evaluated according to the following criteria.

### (Evaluation Criterion MFR)

∘: 5.0 g/10 min or more
x: less than 5.0 g/10 min

TABLE 1

| | Reaction charge amounts | | | | | | | | Par [symbol] lon resin | | | [symbol] lded body | | | | |
|---|---|---|---|---|---|---|---|---|---|---|---|---|---|---|---|---|
| | | | Total | | Total | | | | Degree of | | | | | | 1200 | |
| | Weight of | | weight of | | weight of | | | | substitution | | | Bonding | Bonding | Breaking | impact | [symbol] |
| | [symbol] | | solvent | | [symbol] ting | | (B [symbol] | | Long- | Short- | [symbol] | strength | modulus | strain | strength | [ [symbol] / |
| | (A) | | (B) | | agent (C) | | C)/A | B/C | chain [symbol] | chain [symbol] | [° C.] | [ [symbol] ] | [Gpa] | [ [symbol] ] | [ [symbol] ] | [symbol] min] |
| Synthesis | [symbol] .1 | g | 13 [symbol] | g | 24.0 | g | 18.0 | 5.8 | 0. 38 | 2.1 | 78 | 31 | 0. [symbol] 8 | >10 | ∘ 10.0 | ∘ 5.6 |
| Example 1 | | | | | | | | | | | | | | | | |
| Synthesis | 4.2 | g | [symbol] 1.3 | g | [symbol] .9 | g | 18.4 | 3.9 | 0.31 | 2.2 | 74 | 36 | 0.89 | >10 | ∘ 12.0 | ∘ 4.7 |
| Example 2 | | | | | | | | | | | | | | | | |
| Synthesis | [symbol] .0 | g | 14 [symbol] .6 | g | 13.4 | g | [symbol] | 10.9 | 0. [symbol] 0 | 1.9 | [symbol] | 2 [symbol] | 0.71 | >10 | ∘ 84 | ∘ 8.6 |
| Example 3 | | | | | | | | | | | | | | | | |
| Synthesis | 4.2 | g | [symbol] 1. [symbol] | g | 10.5 | g | 17. 1 | 5.8 | 0.36 | 1.7 | [symbol] | 39 | 0. [symbol] 6 | 7.0 | x 22 | Not |

| | |
|---|---|
| Example 4 | measurable |

[symbol]

indicates data missing or illegible when filed

The results of various evaluations are shown in Table 1. In Synthesis Examples 1 to 3, in which the weight ratio (B+C)/A was 18.0 to 60.0 (wherein A is the dry weight of paramylon, B is the total weight of the solvent, and C is the total weight of the short chain acylating agent and the long-chain acylating agent), the reactions proceeded uniformly, and the IZOD impact strength and heat flowability (MFR) were good.

In contrast, in Synthesis Example 4, in which the weight ratio (B+C)/A was less than 18.0 (wherein A is the dry weight of paramylon, B is the total weight of the solvent, and C is the total weight of the short-chain acylating agent and the long chain acylating agent), the reaction was heterogeneous (the mixture formed lumps on the flask and was unable to be stirred), and the breaking strain, IZOD impact strength, and heat flowability (MFR) were poor.

Although the present invention has been described above with reference to the embodiments and Examples, the present invention is not limited to the above embodiments and Examples. Various modifications that can be understood by one skilled in the art can be made to the configuration and details of the present invention within the scope of the present invention.

### Supplementary Note 1

A method for producing a paramylon-based resin, comprising:
dispersing paramylon having a weight-average molecular weight of 220,000 to 500,000 in a solvent comprising N-methylpyrrolidone and/or pyridine;
acylating hydroxyl groups of the paramylon by adding a short-chain acylating agent, which is acetyl chloride and/or propionyl chloride, and a long-chain acylating agent, which is an acid chloride of a saturated fatty acid having 12 or more carbon atoms, to the paramylon dispersion liquid; and
recovering the paramylon-based resin obtained by the acylation;
wherein in the acylation, the weight ratio (B+C)/A is 17.5 to 60.0, wherein A is the dry weight of paramylon, B is the total weight of the solvent, and C is the total weight of the short-chain acylating agent and the long-chain acylating agent.

### Supplementary Note 2

The method according to supplementary note 1, wherein in the acylation, the weight ratio B/C is 1.0 to 25.0, wherein B is the total weight of the solvent and C is the total weight of the short-chain acylating agent and the long-chain acylating agent.

### Supplementary Note 3

The method according to supplementary note 1 or 2, which is substantially free of hydrolysis of paramylon by an acid or a base.

### Supplementary Note 4

The method according to any of the preceding supplementary notes, wherein the long-chain acylating agent is an acid chloride of at least one fatty acid selected from the group consisting of lauric acid, myristic acid, palmitic acid, stearic acid, arachidic acid and behenic acid.

### Supplementary Note 5

A paramylon-based resin in which at least a portion of the hydrogen atoms of the hydroxyl groups of paramylons having a weight-average molecular weight of 220,000 to 500,000 are substituted with saturated aliphatic acyl groups having 12 or more carbon atoms and acetyl groups and/or propionyl groups.

### Supplementary Note 6

A molding resin composition comprising the paramylon-based resin according to supplementary note 5.

### Supplementary Note 7

A molded body formed using the molding resin composition according to supplementary note 6.

### Supplementary Note 8

The molded body according to supplementary note 7, having an IZOD impact strength of 5.0 KJ/m² or more and an MFR (melt flow rate at 210° C. and a load of 5 kg) of 5.0 g/10 min or more.

What is claimed is:

1. A method for producing a paramylon-based resin, comprising:
dispersing paramylon having a weight-average molecular weight of 220,000 to 500,000 in a solvent comprising N-methylpyrrolidone and/or pyridine;
acylating hydroxyl groups of the paramylon by adding a short-chain acylating agent, which is acetyl chloride and/or propionyl chloride, and a long-chain acylating agent, which is an acid chloride of a saturated fatty acid having 12 or more carbon atoms, to the paramylon dispersion liquid; and
recovering the paramylon-based resin obtained by the acylation;
wherein in the acylation, the weight ratio (B+C)/A is 17.5 to 60.0, wherein A is the dry weight of paramylon, B is the total weight of the solvent, and C is the total weight of the short-chain acylating agent and the long-chain acylating agent.

2. The method according to claim 1, wherein in the acylation, the weight ratio B/C is 1.0 to 25.0, wherein B is the total weight of the solvent and C is the total weight of the short-chain acylating agent and the long-chain acylating agent.

3. The method according to claim 1, which is substantially free of hydrolysis of paramylon by an acid or a base.

4. The method according to claim 1, wherein the long-chain acylating agent is an acid chloride of at least one fatty acid selected from the group consisting of lauric acid, myristic acid, palmitic acid, stearic acid, arachidic acid and behenic acid.

5. A paramylon-based resin in which at least a portion of the hydrogen atoms of the hydroxyl groups of paramylon having a weight-average molecular weight of 220,000 to 500,000 are substituted with saturated aliphatic acyl groups having 12 or more carbon atoms and acetyl groups and/or propionyl groups.

6. A molding resin composition comprising the paramylon-based resin according to claim 5.

7. A molded body formed using the molding resin composition according to claim 6.

8. The method according to claim 2, which is substantially free of hydrolysis of paramylon by an acid or a base.

9. The method according to claim 2, wherein the long-chain acylating agent is an acid chloride of at least one fatty acid selected from the group consisting of lauric acid, myristic acid, palmitic acid, stearic acid, arachidic acid and behenic acid.
